(19) United States
(12) Patent Application Publication
(10) Pub. No.: US 2013/0026859 A1
(43) Pub. Date: Jan. 31, 2013

(54) LINEAR MOTOR

(71) Applicants: Han Kyung BAE, Gyunggi-do (KR); Changsung Sean KIM, Gyunggi-do (KR); Chang Hwan CHOI, Gyunggi-do (KR); Guen Hong LEE, Seoul (KR)

(72) Inventors: Han Kyung BAE, Gyunggi-do (KR); Changsung Sean KIM, Gyunggi-do (KR); Chang Hwan CHOI, Gyunggi-do (KR); Guen Hong LEE, Seoul (KR)

(73) Assignee: SAMSUNG ELECTRO-MECHANICS CO., LTD., Gyunggi-do (KR)

(21) Appl. No.: 13/327,174

(22) Filed: Dec. 15, 2011

(30) Foreign Application Priority Data
Jul. 29, 2011 (KR) 10-2011-0075923

(51) Int. Cl. H02K 41/03

(52) U.S. Cl. 310/12.18

(57) ABSTRACT

Disclosed herein is a linear motor including: a first stator part including a plurality of stator cores having coils wound therearound multiple times and arranged to be spaced apart from each other by predetermined intervals in a longitudinal direction; a second stator part arranged to be spaced apart from the first stator part by a predetermined interval in a transversal direction so as to face the first stator part and including a plurality of stator cores having coils wound therearound multiple times and arranged to be spaced apart from each other by predetermined intervals in the longitudinal direction so that the second stator part is in parallel with the first stator part; and a mover arranged in an interval formed by the first and second stator parts and moving linearly.

### CROSS REFERENCE TO RELATED APPLICATION

This application claims the benefit of Korean Patent Application No. 10-2011-0075923, filed on Jul. 29, 2011, entitled “Linear Motor” which is hereby incorporated by reference in its entirety into this application.

### BACKGROUND OF THE INVENTION

1. Technical Field

The present invention relates to a linear motor.

2. Description of the Related Art

According to the prior art, linear driving force has been generated using a rotation motor. To this end, an additional mechanical device configured of a gear system using a screw, a chain, and the like, for converting rotational force of the rotation motor into linear driving force has been required.

However, the gear system is used, thereby causing energy loss at the time of conversion of the rotational force into the linear driving force.

In addition, noise is generated in the mechanical device.

### SUMMARY OF THE INVENTION

The present invention has been made in an effort to provide a linear motor generating driving force for linear movement using reluctance torque according to a change in magnetic resistance, which is a driving scheme of a switched reluctance motor.

Further, the present invention has been made in an effort to provide a linear motor in which a mechanical converting device for converting rotational force into linear driving force is not additionally used, such that energy loss and mechanical noise are not generated.

According to a preferred embodiment of the present invention, there is provided a linear motor including: a first stator part including a plurality of stator cores having coils wound therearound multiple times and arranged to be spaced apart from each other by predetermined intervals in a longitudinal direction; a second stator part arranged to be spaced apart from the first stator part by a predetermined interval in a transversal direction so as to face the first stator part and including a plurality of stator cores having coils wound therearound multiple times and arranged to be spaced apart from each other by predetermined intervals in the longitudinal direction so that the second stator part is in parallel with the first stator part; and a mover arranged in an interval formed by the first and second stator parts and moving linearly.

The stator core may include: a stator core yoke that is perpendicular to a movement direction of the mover; a first stator core salient pole bent and protruded from one end of the stator core yoke toward the mover; and a second stator core salient pole bent and protruded from the other end of the stator core yoke toward the mover, and the stator core has a C shaped cross section with respect to a direction in which the mover moves linearly.

The mover may include: a plurality of upper translators arranged between a plurality of first stator core salient poles configuring the first stator part and a plurality of first stator core salient poles configuring the second stator part; and a plurality of lower translators arranged between a plurality of second stator core salient poles configuring the first stator part and a plurality of second stator core salient poles configuring the second stator part.

The upper and lower translators may include a plurality of protrusion parts protruded from one side thereof so that they are adjacent to the first and second stator parts.

The upper and lower translators may include: a plurality of first protrusion parts protruded from one side thereof so that the upper and lower translators are adjacent to the first and second stator parts; and a plurality of second protrusion parts protruded from the other side thereof so that the upper and lower translators are adjacent to the first and second stator parts.

The coils may be selectively wound around any one of the stator core yoke, the first stator core salient pole, and the second stator core salient pole that configure the stator core multiple times.

### BRIEF DESCRIPTION OF THE DRAWINGS

FIG. 1 is a schematic assembly perspective view showing a linear motor according to a preferred embodiment of the present invention;

FIG. 2 is a front view of the linear motor shown in FIG. 1;

FIG. 3 is a perspective view showing another preferred embodiment of a translator configuring a linear motor according to a preferred embodiment of the present invention;

FIG. 4 is a perspective view showing another preferred embodiment of a translator configuring a linear motor according to a preferred embodiment of the present invention; and

FIG. 5 is a perspective view showing a stator core having a coil wound therearound according to a preferred embodiment of the present invention.

### DESCRIPTION OF THE PREFERRED EMBODIMENTS

Various objects, advantages and features of the invention will become apparent from the following description of embodiments with reference to the accompanying drawings. In the specification, in adding reference numerals to components throughout the drawings, it is to be noted that like reference numerals designate like components even though components are shown in different drawings. Further, terms used in the specification, ‘first’, ‘second’, etc. can be used to describe various components, but the components are not to be construed as being limited to the terms. The terms are only used to differentiate one component from other components. Further, when it is determined that the detailed description of the known art related to the present invention may obscure the gist of the present invention, the detailed description thereof will be omitted.

Hereinafter, preferred embodiments of the present invention will be described in detail with reference to the accompanying drawings.

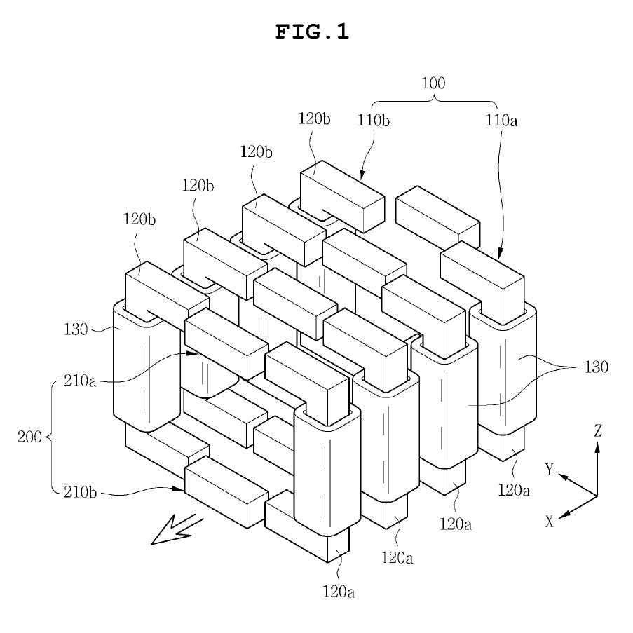

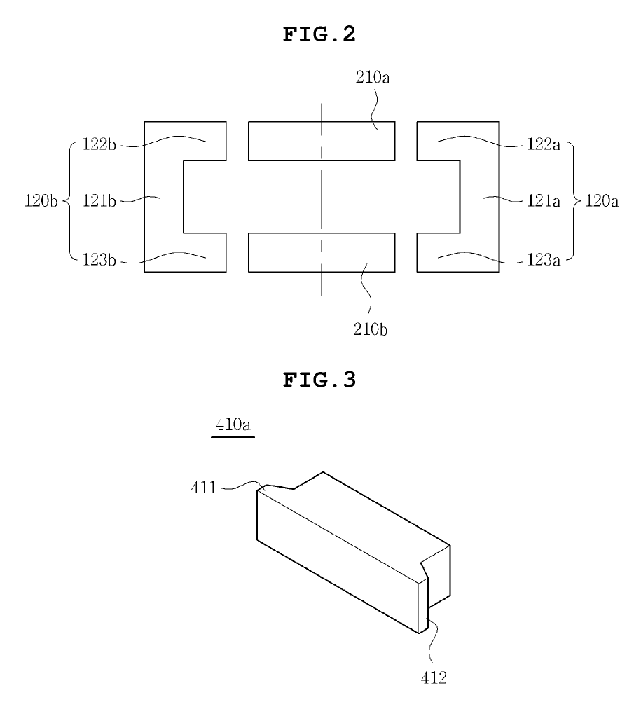

FIG. 1 is a schematic assembly perspective view showing a linear motor according to a preferred embodiment of the present invention; and FIG. 2 is a front view of the linear motor shown in FIG. 1. As shown, the linear motor includes a stator 100 configured of a plurality of stator parts 110a and 110b and a mover 200 facing the plurality of stator parts 110a and 110b and moving linearly.

More specifically, the linear motor includes a first stator part 110a arranged to be spaced apart from the mover 200 at a predetermined interval in a direction of one side thereof and a second stator part 110b arranged to be spaced apart from the mover 200 at a predetermined interval in a direction of the other side thereof.

In addition, the first stator part 110a includes a plurality of stator cores 120a arranged to be spaced apart from each other at predetermined intervals in a longitudinal direction in which the mover 200 moves linearly.

Further, coils 130 having a power applied from the outside thereto are wound around the plurality of stator cores 120a configuring the first stator part 110a multiple times.

In addition, the second stator part 110b may be arranged to be spaced apart from the first stator part 110a by a predetermined interval in a transversal direction perpendicular to a direction in which the mover 200 moves linearly so that it faces the first stator part 110a.

More specifically, the second stator part 110b is arranged in a longitudinal direction in which the mover 200 moves linearly so that it is in parallel with the first stator part 110a.

That is, as shown in FIG. 1, the second stator part 110b includes a plurality of stator cores 120b having the same shapes as those of the plurality of stator cores 120a configuring the first stator part 110a described above.

In addition, the plurality of stator cores 120b configuring the second stator part 110b are arranged to be spaced apart from each other at predetermined intervals in the longitudinal direction in which the mover 200 moves linearly so that they face the plurality of stator cores 120a configuring the first stator part 110a to be in parallel therewith.

According to the preferred embodiment of the present invention shown in FIG. 2, the stator cores 120a configuring the first stator part 110a and the stator cores 120b configuring the second stator part 110b have the same shape.

Therefore, a description will be provided based on the stator core 120a. The stator core 120a includes a stator core yoke 121a and a plurality of stator core salient poles 122a and 123a.

More specifically, the stator core yoke 121a may have a bar shape so that it is perpendicular to a movement direction of the mover 200.

In addition, the stator core 120a includes a first stator core salient pole 122a and a second stator core salient pole 123a that are protruded from the stator core yoke 121a.

More specifically, the first stator core salient pole 122a is bent and protruded from one end of the stator core yoke 121 a toward the mover 200

Further, the second stator core salient pole 123a is bent and protruded from the other end of the stator core yoke 121a toward the mover 200.

Therefore, the stator core 120a configured of the stator core yoke 121a and the first and second stator core salient poles 122a and 123a has a C or ⊂ shaped cross section with respect to a direction in which the mover 200 moves linearly.

According to the preferred embodiment of the present invention, the mover 200 is arranged in an interval formed by the first and second stator parts 110a and 110b and moves linearly.

More specifically, the mover 200 includes a plurality of upper translators 210a and a plurality of lower translator 210b.

In addition, the upper and lower translators 210a and 210b may have the same shape. Further, each of the upper and lower translators 210a and 210b may be arranged to face each other.

According to the preferred embodiment of the present invention, as shown in FIGS. 1 to and 2, the upper translator 210a may be formed to have a hexahedron shape by stacking several sheets of iron core panels made of a metal material.

In addition, the plurality of upper translators 210a are arranged between the plurality of first stator core salient poles 122a configuring the first stator part 110a and the plurality of first stator core salient poles 122b configuring the second stator part 110b.

In addition, the plurality of lower translators 210a are arranged between the plurality of second stator core salient poles 123a configuring the first stator part 110a and the plurality of second stator core salient poles 123b configuring the second stator part 110b.

In addition, the coils 130 wound multiple times around the first and second stator parts 110a and 110b are wound around the stator core yokes 121a and 121b each configuring the stator cores 120a and 120b as shown in FIG. 1.

In addition, although the coils are wound around the stator core yokes in the preferred embodiment of the present invention, coils 331 or 332 may be selectively wound around any one of a first stator core salient pole 322a or a second stator core salient pole 323a configuring a stator core 320 a multiple times.

Driving of the linear motor according to the preferred embodiment of the present invention shown in FIG. 1 will be described below. First, a power is applied only to the coil 130 wound around one stator core yoke 121a configuring the first stator part 110a and the coil 130 facing the coil 130 wound around one stator core yoke 121a and wound around one stator core yoke 121b configuring the second stator part 110b.

Therefore, electromagnetic force is generated in the stator core 120a configuring the first stator part 110a and the stator core 120b configuring the second stator part 110b, such that the first and second stator parts 110a and 110b are excited.

Then, the mover 200 arranged between the first and second stator parts 110a and 110b moves linearly by magnetic resistance between the mover 200 and the first and second stator parts 110a and 110b.

More specifically, one upper translator 210a arranged between the first and second stator parts 110a and 110b moves linearly by magnetic resistance between the upper translator 210a and the first stator core salient pole 122a configuring the first stator part 110a and the first stator core salient pole 122b configuring the second stator part 110b.

In addition, one lower translator 210b arranged between the first and second stator parts 110a and 110b and disposed to face one upper translator 210a described above moves linearly together with the upper translator 210a by magnetic resistance between the lower translator 210b and the second stator core salient pole 123a configuring the first stator part 110a and the second stator core salient pole 123b configuring the second stator part 110b.

Next, the supply of the power to the stator core 120a described above is stopped, and the power is applied only to the coil 130 wound around another stator core yoke 121 a arranged in a direction in which the mover 200 is to move.

More specifically, a power is applied only to the coil 130 wound around another stator core yoke 121a configuring the first stator part 110a and the coil 130 facing the coil 130 wound around one stator core yoke 121b and wound around another stator core yoke 121b configuring the second stator part 110b.

Therefore, as described above, the electromagnetic force is generated in the stator core 120a configuring the first stator part 110a and the stator core 120b configuring the second stator part 110b, such that the first and second stator parts 110a and 110b are again excited.

Then, another mover 200 arranged between the first and second stator parts 110a and 110b moves linearly by the excited first and second stator parts 110a and 110b.

More specifically, the upper and lower translators 210a and 210b configuring the mover 200 moves linearly by the stator core 120a configuring the excited first stator part 110a and the stator core 120b configuring the excited second stator part 110b in the same scheme as the above-mentioned scheme.

In addition, the linear motor according to the preferred embodiment of the present invention may further include a connection part (not shown) connecting the upper and lower translators 210a and 210b to each other and having a bar shape.

Therefore, the upper and lower translators 210a and 210b are connected integrally with each other by the connection part having the bar shape, such that the mover 200 may be accurately driven linearly at the time driving thereof in a linear direction.

Further, in the case of a conveyor belt conveying a conveying object in any direction, each of the upper and lower translators 210a and 210b is coupled to a lower of a belt configuring the conveyor belt, thereby making it possible to drive the conveyor belt.

In addition, the linear motor according to the preferred embodiment of the present invention sequentially performs or stops the supply of a power to the coils 130 wound around the plurality of stator cores 120a and 120b each configuring the first and second stator parts 110a and 110b arranged in a direction in which the mover 200 is to move as in the above-mentioned scheme, thereby making it possible to linearly move the mover 200 in a desired direction.

Further, as shown in FIG. 1, the mover 200 may be moved in a straight line direction. In addition, when the plurality of stator cores 120a configuring the first stator part 110a and the plurality of stator core 120b configuring the second stator part 110b are arranged to have a predetermined radius of curvature, the mover 200 may be moved in various directions desired by users.

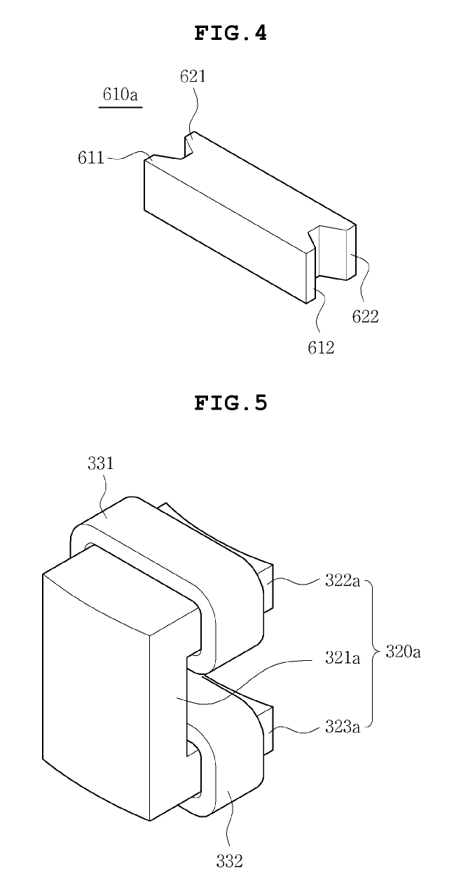

FIG. 3 is a perspective view showing another preferred embodiment of a translator configuring a linear motor according to a preferred embodiment of the present invention; and FIG. 4 is a perspective view showing another preferred embodiment of a translator configuring a linear motor according to a preferred embodiment of the present invention.

As shown in FIG. 3, an upper translator 410a includes a plurality of protrusion parts 411 and 412 protruded from one side thereof.

More specifically, the plurality of protrusion parts 411 and 412 may be protruded so as to be adjacent to the first and second stator parts 110a and 110b.

That is, the upper translator 410a includes one protrusion part 411 protruded from one side thereof so that it is adjacent to the first stator core salient pole 122a configuring the first stator part 110a.

In addition, the upper translator 410a includes one protrusion part 412 protruded from one side thereof so that it is adjacent to the first stator core salient pole 122b configuring the second stator part 110b.

Furthermore, a lower translator (not shown) includes one protrusion part protruded from one side thereof so that it is adjacent to the second stator core salient pole 123a configuring the first stator part 110a, similar to the above-mentioned upper translator 410a.

In addition, the lower translator includes another protrusion part protruded from one side thereof so that it is adjacent to the second stator core salient pole 123b configuring the second stator part 110b.

Therefore, the upper translator 410a includes the plurality of protrusion parts 411 and 412, such that the linear motor may perform self starting at the time of initial driving thereof.

As shown in FIG. 4, an upper modified translator 610a includes a plurality of protrusion parts 611, 612, 621, and 622 protruded from one side and the other side thereof.

More specifically, the upper translator 610a includes a plurality of first protrusion parts 611 and 612 that are protruded from one side thereof and a plurality of second protrusion parts 621 and 622 that are protruded from the other side thereof and having the same shapes as those of the first protrusion parts 611 and 612.

Therefore, the mover configuring the linear motor may perform self starting in two directions.

As set forth above, the linear motor according to the preferred embodiment of the present invention does not require an additional mechanical converting device, thereby making it possible to reduce energy loss due to mechanical friction.

In addition, since the linear motor according to the preferred embodiment of the present invention uses a driving scheme of a switched reluctance motor, it has a simple structure, thereby making it possible to improve manufacturing yield.

Further, since the linear motor according to the preferred embodiment of the present invention does not cause mechanical friction, noise may not be generated in the linear motor and a lifespan of the linear motor may be improved.

Furthermore, the linear motor according to the preferred embodiment of the present invention may infinitely perform linear movement in a direction desired by users.

Although the preferred embodiments of the present invention have been disclosed for illustrative purposes, they are for specifically explaining the present invention and thus a linear motor according to the present invention is not limited thereto, but those skilled in the art will appreciate that various modifications, additions and substitutions are possible, without departing from the scope and spirit of the invention as disclosed in the accompanying claims.

Accordingly, such modifications, additions and substitutions should also be understood to fall within the scope of the present invention.

What is claimed is:

1. A linear motor comprising:
a first stator part including a plurality of stator cores having coils wound therearound multiple times and arranged to be spaced apart from each other by predetermined intervals in a longitudinal direction;
a second stator part arranged to be spaced apart from the first stator part by a predetermined interval in a transversal direction so as to face the first stator part and including a plurality of stator cores having coils wound therearound multiple times and arranged to be spaced apart from each other by predetermined intervals in the longitudinal direction so that the second stator part is in parallel with the first stator part; and
a mover arranged in an interval formed by the first and second stator parts and moving linearly.

2. The linear motor as set forth in claim 1, wherein the stator core includes:
a stator core yoke that is perpendicular to a movement direction of the mover;
a first stator core salient pole bent and protruded from one end of the stator core yoke toward the mover; and
a second stator core salient pole bent and protruded from the other end of the stator core yoke toward the mover, and the stator core has a C shaped cross section with respect to a direction in which the mover moves linearly.

3. The linear motor as set forth in claim 2, wherein the mover includes:
a plurality of upper translators arranged between a plurality of first stator core salient poles configuring the first stator part and a plurality of first stator core salient poles configuring the second stator part; and
a plurality of lower translators arranged between a plurality of second stator core salient poles configuring the first stator part and a plurality of second stator core salient poles configuring the second stator part.

4. The linear motor as set forth in claim 3, wherein the upper and lower translators include a plurality of protrusion parts protruded from one side thereof so that they are adjacent to the first and second stator parts.

5. The linear motor as set forth in claim 3, wherein the upper and lower translators include:
a plurality of first protrusion parts protruded from one side thereof so that the upper and lower translators are adjacent to the first and second stator parts; and
a plurality of second protrusion parts protruded from the other side thereof so that the upper and lower translators are adjacent to the first and second stator parts.

6. The linear motor as set forth in claim 2, wherein the coils are selectively wound around any one of the stator core yoke, the first stator core salient pole, and the second stator core salient pole that configure the stator core multiple times.
